(19) United States
(12) Patent Application Publication
(10) Pub. No.: US 2024/0308295 A1
(43) Pub. Date: Sep. 19, 2024

(54) AIR VENT DAMPER APPARATUS AND METHOD

(71) Applicant: MJT Car Accessories LLC, The Woodlands, TX (US)

(72) Inventors: Macey Elizabeth Calhoun, The Woodlands, TX (US); Josemanuel Benavides, The Woodlands, TX (US)

(21) Appl. No.: 18/122,259

(22) Filed: Mar. 16, 2023

(51) Int. Cl. B60H 1/00; F16B 1/00

(52) U.S. Cl. CPC B60H 1/00678; F16B 1/00; B60H 2001/007; F16B 2200/83

(57) ABSTRACT

An air vent damper apparatus including first and second retention devices each having a respective body portion. At least one of the retention devices includes at least a first catch member, and at least one of the retention devices includes a second catch member. The first and second catch members define differing damper positions. The apparatus also includes a damper having opposed first and second edges, wherein the damper is pivotally coupled between the first and second retention devices. Each of the first and second edges has a respective third catch member that is magnetically attracted to the first and second catch members the first and second retention devices, such that the damper can be selectively configured in an first position by aligning the third catch member with the first catch member and in a second position by aligning the third catch member with the second catch member.

### BACKGROUND OF THE INVENTION

This disclosure relates to an air vent damper apparatus for controlling airflow into the passenger compartment of an automotive vehicle.

Automotive vehicle air conditioning and ventilation systems may include air vent control assemblies that vehicle occupants can use to control the amount of air flowing into a vehicle passenger compartment from an air vent, and in some cases, to control the direction of airflow. Some air vent control assemblies include damper doors that are pivotally supported near the exit or exhaust end of air passages and that provide fluid communication between air sources and passenger compartments. Such assemblies may also include one or more air louvers that are pivotable to direct airflow from air passages into passenger compartments. Although it is known in the art for vehicles having air conditioning and ventilation systems to include air vent control assemblies, not all vehicles having air vents do so as produced by the original vehicle manufacturer.

### BRIEF SUMMARY

The present application appreciates that it would be desirable to provide an air vent damper apparatus that a passenger can utilize to selectively seal off or limit the amount of air that is allowed to enter the passenger compartment of a vehicle through an air vent. The present application additionally appreciates that it would be desirable to provide such an air vent damper apparatus as an after-market product that can be selectively installed by a user into an air vent of a vehicle and, if desired, removed from the air vent of the vehicle. Further, the present application appreciates that it would additionally be desirable if the air vent damper apparatus can be manually installed into and retained within the air vent and/or manually removed from the air vent without the use of tools.

In one or more embodiments, an air vent damper apparatus includes first and second retention devices each having a respective body portion. At least one of the retention devices includes at least a first catch member, and at least one of the retention devices includes a second catch member. The first and second catch members define differing damper positions. The apparatus also includes a damper having opposed first and second edges, wherein the damper is pivotally coupled between the first and second retention devices. Each of the first and second edges has a respective third catch member that is magnetically attracted to the first and second catch members the first and second retention devices, such that the damper can be selectively configured in an first position by aligning the third catch member with the first catch member and in a second position by aligning the third catch member with the second catch member.

Additional features and a method of installing the air vent damper apparatus are described further herein.

### BRIEF DESCRIPTION OF THE SEVERAL VIEWS OF THE DRAWINGS

FIG. 1 illustrates an interior of an exemplary passenger compartment of a vehicle including an air vent in accordance with one embodiment;

FIG. 2 depicts an exemplary retention device suitable for use in an air vent damper apparatus in accordance with one embodiment;

FIG. 3 illustrates an exemplary damper suitable for use in an air vent damper apparatus in accordance with one embodiment;

FIGS. 4A-4B respectively depict side elevation and front elevation views of an exemplary air vent damper apparatus in an open position in accordance with one embodiment;

FIGS. 5A-5B respectively illustrate side elevation and front elevation views of an exemplary air vent damper apparatus in a closed position in accordance with one embodiment; and

FIG. 6 depicts a side elevation view of an exemplary air vent damper apparatus as installed in an air vent of a vehicle in accordance with one embodiment.

### DETAILED DESCRIPTION

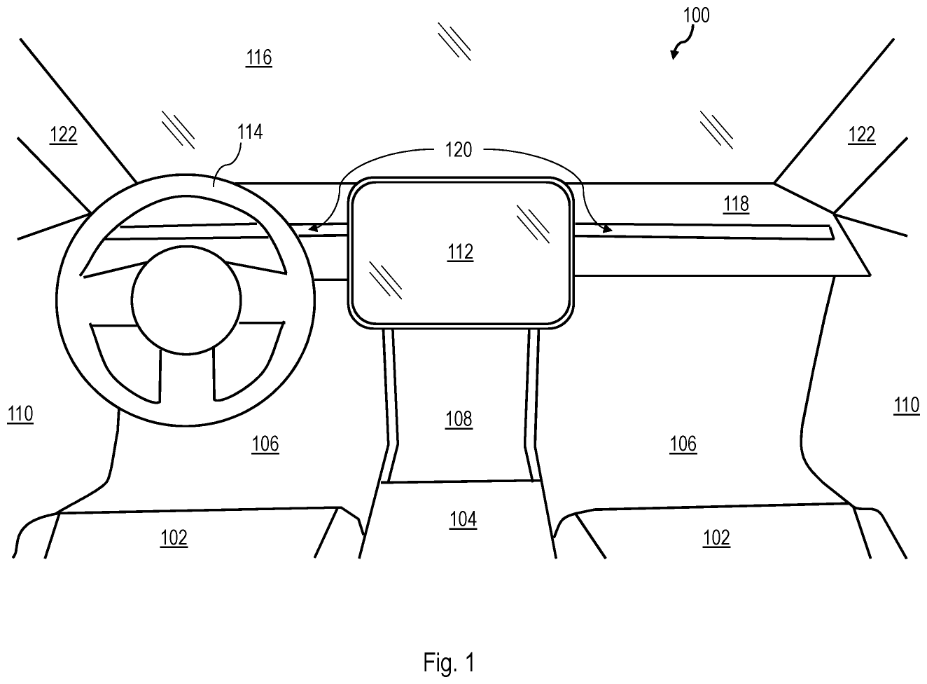

With reference now to the figures and with particular reference to FIG. 1, there is illustrated a partial view of the interior of an exemplary passenger compartment 100 of a vehicle having an air vent in accordance with one embodiment. In this example, passenger compartment 100 is bounded in part by doors 110, driver's side and passenger's side A-pillars 122, and windshield 116. Passenger compartment 100 is equipped with passenger seats 102 and footwells 106 for accommodating human passengers in a seated position. Between passenger seats 102 is an armrest 104 and a central storage compartment 108. Passenger compartment 100 additionally includes a steering wheel 114 for controlling the direction of travel of the passenger vehicle, an infotainment system including a touchscreen display 112, and a dashboard 118 including an air vent 120. Air vent 120 is a component of the vehicle air conditioning and ventilation system through which air flow is supplied to the interior of passenger compartment 100.

Notably, in the illustrated embodiment, air vent 120 as originally manufactured lacks an air vent damper that permits one of the passengers within passenger compartment 100 to restrict and/or to substantially block the air flow from air vent 120 into the portion of the passenger compartment 100 occupied by that passenger while permitting the other passenger to enjoy air flow from air vent 120. Thus, if one passenger provides a command (e.g., through touchscreen display 112) to the air conditioning and ventilation system of the vehicle that a specified level of air flow (including no air flow) is to be provided through air vent 120, that specified level of air flow is provided from air vent 120 on both the driver's side and passenger's side of the passenger compartment 100. As will be appreciated by those skilled in the art, the inability of an individual passenger to tailor the air flow from air vent 120 to that passenger's personal temperature and air flow preferences and the ambient conditions (e.g., the position of the sun, the warmth of the passenger's clothing, etc.) can lead to discomfort and/or dissatisfaction with the passenger's experience with the vehicle. The present application addresses this and other problems in the art by providing an air vent damper apparatus suitable for after-market installation into and removal from an air vent 120 without tools.

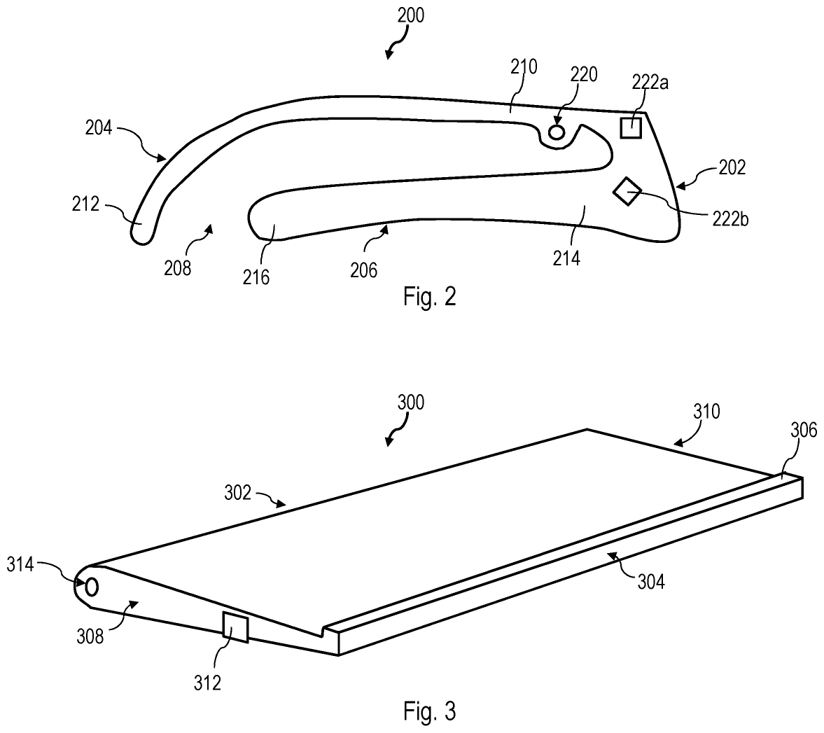

Referring now to FIG. 2, there is depicted an exemplary retention device suitable for use in an air vent damper apparatus in accordance with one embodiment. In this example, retention device 200 is realized as a spring clip for retaining an air vent damper apparatus within the interior volume of air vent 120. Retention device 200 can be formed, for example, by injection molding, 3D printing, or a Computerized Numerical Control (CNC)-directed cutting, from a plastic, elastomer, or metal (preferably a non-ferrous, such as beryllium copper). Retention device 200 is preferably flexible and resilient.

In the illustrated embodiment, retention device 200 is a unitary member including a body portion 202 from which extend an elongate curved finger portion 204 and an arm portion 206 spaced apart from finger portion 204 by a channel 208. Finger portion 204 includes a proximate end 210 adjoining body portion 202 and a distal end 212; arm portion 206 similarly includes a proximate end 214 adjoining body portion 202 and a distal portion 216. At or near where proximate end 210 of finger portion 204 meets body portion 202, retention device 200 includes a protrusion into channel 208 having formed therein a recess (e.g., through hole 220) for receiving and retaining therein a pivot member (e.g., a screw or pin) for supporting a damper that is pivotal with respect to retention device 200.

In the example of FIG. 2, body portion 202 of retention device 200 additionally includes damper retention features for temporarily and selectively retaining a damper in a desired pivotal relation to retention device 200. In some embodiments, the damper retention features can include, for example, a plurality of bosses extending outwardly from body portion 202 or recesses in body portion 202 that cooperate with corresponding features on the damper to retain the damper in a desired pivotal relationship with respect to retention device 200. In an alternative embodiment depicted in FIG. 2, the damper retention features include two or more catch members 222a, 222b, . . . , which can be formed integral to body portion 202 of retention member 200 or received within recesses in body portion 202. In some embodiments, catch members 222a, 222b are formed of iron, steel, or other material to which a magnet is attracted. In other embodiments, catch members 222a, 222b comprise magnets, for example, neodymium permanent magnets. In this example, catch member 222a corresponds to an “open” position of the pivotal damper that allows airflow from an air vent 120, and catch member 222b corresponds to a “closed” position of the pivotal damper that restricts or substantially blocks air flow from air vent 120. Those skilled in the art should appreciate that one or more additional catch members 222 can optionally be included within body portion 202 intermediate catch members 222a, 222b to define one or more additional damper positions intermediate the open and closed positions that restrict, but do not block airflow.

With reference now to FIG. 3, there is illustrated an exemplary damper 300 suitable for use in an air vent damper apparatus in accordance with one embodiment. In this example, damper 300 is a unitary member, which can be formed, for example, by injection molding, 3D printing, or a Computerized Numerical Control (CNC)-directed cutting, from a plastic or metal (which may be ferrous on non-ferrous). Damper 300 can have, but is not required to have, a generally rectangular overall shape and can have any overall length suitable for installation within the air vent 120 of a target vehicle. In the embodiment FIG. 3 in which damper 300 has a generally rectangular overall form, damper 300 includes opposing first and second edges 308 and 310, respectively, as well as opposing third and fourth edges 302 and 304, respectively. Third edge 302 is configured to be the leading edge in the air flow in air vent 120, and fourth edge 304 is configured to be the trailing edge in the air flow within air vent 120. In embodiments in which damper 300 is an elongate member, fourth edge 304 can optionally be formed with an integral lip 306 to provide additional rigidity and resistance to flexure as damper 300 is manipulated.

Although only first edge 308 of damper 300 is illustrated in FIG. 3 in detail, first and second edges 308, 310 are preferably similar or corresponding in design. In this example, each of first and second edges 308, 310 has formed therein a recess 314 for receiving therein a pivot member that pivotally couples that edge 308 or 310 to a respective retention member 200. In at least embodiments in which damper 300 is not formed of a magnetically attracted material (e.g., ferrous metal), at least one of (and preferably both of) first and second edges 308, 310 of damper 300 preferably includes a respective catch member 312 disposed on, formed within, or embedded in a recess within the edge(s). Each catch member 312 is formed of a material that is magnetically attracted to the catch members 222a, 222b in the retention device 200 pivotally coupled to its edge 308, 310 of damper 300. By virtue of the magnetic attraction between catch members 222a, 222b and catch members 312 (and/or damper 300 itself if it is formed of a magnetically attracted material), a passenger of a vehicle can selectively manually set damper 300, and damper 300 can be magnetically retained, in either the open position or the closed position, as desired by the passenger. The magnetic force between catch members 312 and 222a or 222b is preferably selected to retain damper 300 is the desired position during operation of the vehicle, while still allowing the passenger to comfortably change positions of damper 300 as desired using only manual force. In embodiments in which catch members 222 and 312 are all implemented with magnets, care must be taken to arrange the magnetic poles of catch members 222, 312 so that catch members 222, 312 attract rather than repel each other.

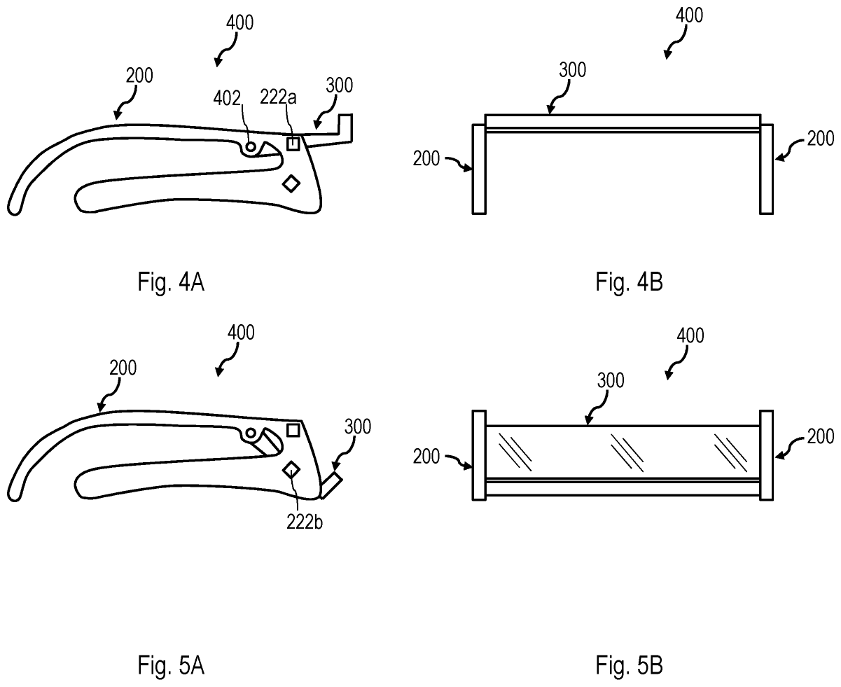

Referring now to FIGS. 4A-4B, there are respectively depicted side elevation and front elevation views of an exemplary air vent damper apparatus 400 configured in an open position in accordance with one embodiment. As shown, in this example, air vent damper apparatus 400 includes two retention devices 200 pivotally coupled to opposing first and second edges 308, 310 of damper 300 by respective pivot members 402. In this configuration, the catch member 312 on each of the first and second edges 308, 310 of damper 300 is magnetically coupled to the catch member 222a of a respective one of the retention devices 200, allowing air flow substantially unobstructed by damper 300.

FIGS. 5A-5B respectively illustrate side elevation and front elevation views of exemplary air vent damper apparatus 400 of FIGS. 4A-4B in a closed position in accordance with one embodiment. In this configuration, the catch member 312 disposed on each of the first and second edges 308, 310 of damper 300 is magnetically coupled to the catch member 222b of a respective one of the retention devices 200. As a result, damper 300 can substantially restrict or block air flow from an air vent 120 (or portion of an air vent 120) into which air vent damper apparatus 400 is installed.

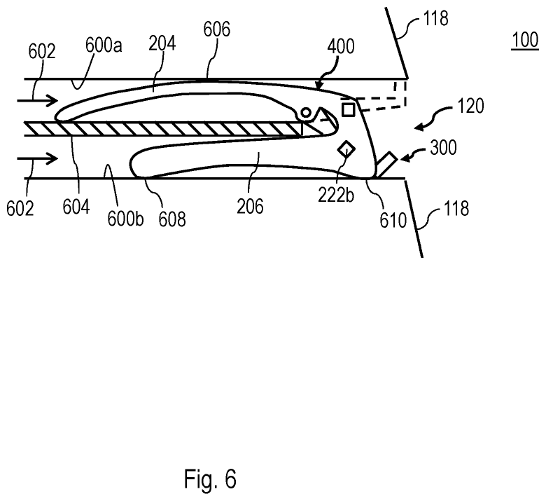

Referring now to FIG. 6, there is depicted a side elevation view of an exemplary air vent damper apparatus as installed in an air vent 120 of a vehicle in accordance with one embodiment. Air vent 120, which is bounded in part by sidewalls 600a, 600b, channels airflow flowing in the direction of arrows 602 from the vehicle air conditioning and ventilation system into passenger compartment 100. In this embodiment, air vent 120 optionally includes a central baffle 604.

Retention devices 200 of an air vent damper apparatus 400 are configured to cooperate with sidewalls 600a, 600b of air vent 120 (and if present, central baffle 604) in order to permit the air vent damper apparatus 400 to be removably installed and retained within air vent 120 without the use of tools. In order to install an air vent damper apparatus 400 within air vent 120, a user manually inserts the air vent damper apparatus 400 into air vent 120 with the respective distal ends 212, 216 of the finger portions 204 and arm portions 206 of the retention devices 200 facing the air flow. As seen by comparison of FIGS. 4A, 5A with FIG. 6, as the finger portions 204 of the retention devices 200 advance into air vent 120, distal ends 212 of finger portions 204 will contact central baffle 604 and resiliently deform away from arm portions 206. In addition, the overall form of retention devices 200 will be resiliently compressed by contact of contact regions 606, 608, and 610 with sidewalls 600a, 600b. The advance of air vent damper apparatus 400 is stopped based on the user's judgment of the appropriate positioning of the air vent damper apparatus 400 within air vent 120 and/or the frictional engagement between retention devices 200 with sidewalls 600a, 600b (and if present central baffle 604) and/or the contact of central baffle 604 with a surface within the channels 208 of retention devices 200 (e.g., a surface of the projection into channel 208 containing through hole 220 or a surface of body portion 202). In the illustrated example, once installed, the air vent damper apparatus 400 is retained within air vent 120 by the spring force of retention devices 200 and the frictional engagement of finger portions 204 and arm portions 206 of retention devices 200 with both one of sidewalls 600a, 600b and central baffle 602. It will be appreciated that the degree of frictional engagement can be selectively controlled by the choice of material (e.g., based on the materials' respective static coefficients of friction) and surface finish utilized for retention devices 200.

With air vent damper apparatus 400 installed in air vent 120, a passenger can then control air flow directed to that passenger's portion of the passenger compartment 100 by manually and selectively rotating damper 300 between the closed position (shown in hard line in FIG. 6) and the open position (shown in phantom line in FIG. 6). Damper 300 is magnetically retained in the selected position by catch members 222, 312 as described above. If desired, the user can uninstall the air vent damper apparatus 400 from air vent 120 by simply manually grasping the air vent damper apparatus 400 and withdrawing it from air vent 120.

As has been described, in at least one embodiment, an air vent damper apparatus including first and second retention devices each having a respective body portion. At least one of the retention devices includes at least a first catch member, and at least one of the retention devices includes a second catch member. The first and second catch members define differing damper positions. The apparatus also includes a damper having opposed first and second edges, wherein the damper is pivotally coupled between the first and second retention devices. Each of the first and second edges has a respective third catch member that is magnetically attracted to the first and second catch members the first and second retention devices, such that the damper can be selectively configured in an first position by aligning the third catch member with the first catch member and in a second position by aligning the third catch member with the second catch member.

While the present invention has been particularly shown as described with reference to one or more preferred embodiments, it will be understood by those skilled in the art that various changes in form and detail may be made therein without departing from the spirit and scope of the invention. For example, although exemplary embodiments of retention devices utilized to retain an air vent damper apparatus within an air vent are disclosed herein, those skilled in the art will appreciate that in various use cases alternative types, shapes, and sizes of retention devices can be employed and that the types, shapes, and sizes of the retention devices can be selected, for example, based upon the size and configuration of an air vent of the target vehicle. In addition, while an embodiment has been described that includes at least two catch members in each retention device and a respective catch member on each of two opposing edges of a damper, those skilled in the art will appreciate that fewer catch members can be employed. For example, if damper 300 is formed of a magnetically attracted material, damper 300 can itself serve as a catch member and no separate element is required. Further, in some embodiments, one or both of retention devices 200 can include fewer catch members than the defined number of damper positions. For example, a first retention device 200 coupled to the first edge 308 of damper 300 can include a catch member 222a but not a catch member 222b, while a second retention device 200 coupled to the second edge 310 of damper 300 can include a catch member 222b but not a catch member 222a. This arrangement would still permit damper 300 to be retained in the open and closed positions illustrated in FIGS. 4A-4B and 5A-5B, respectively.

The disclosure in the figures and the written description of specific structures and functions is not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. An air vent damper apparatus, comprising:
first and second retention devices each having a respective body portion, wherein at least one retention device among the first and second retention devices includes at least a first catch member and at least one retention device among the first and second catch members includes a second catch member, and wherein the first and second catch members define differing damper positions; and
a damper having opposed first and second edges, wherein the damper is pivotally coupled between the first and second retention devices with the first edge adjacent the first retention device and the second edge adjacent the second retention device, wherein each of the first and second edges has a respective third catch member magnetically attracted to the first and second catch members the first and second retention devices, such that the damper can be selectively configured in an first position by aligning the third catch member with the first catch member and can be selective configured in a second position by aligning the third catch member with the second catch member.

2. The air vent damper apparatus of claim 1, wherein the first and second catch members comprise magnets.

3. The air vent damper apparatus of claim 1, wherein the third catch member comprises a magnet.

4. The air vent damper apparatus of claim 1, wherein the first and second retention devices comprise spring clips.

5. The air vent damper apparatus of claim 1, wherein the first and second retention devices are formed of a resilient material.

6. The air vent damper apparatus of claim 5, wherein the resilient material is one of the following: a metal, a plastic, an elastomer.

7. The air vent damper apparatus of claim 1, wherein each of the first and second retention devices includes a finger portion and an arm portion extending from the body portion and spaced apart by a channel.

8. An air vent assembly, comprising:
an air vent of an automotive vehicle, wherein the air vent includes at least first and second sidewalls; and
the air vent damper apparatus of claim 1 disposed within the air vent, wherein the first and second retention devices engage the first and second sidewalls.

9. The air vent assembly of claim 8, wherein:
the air vent includes a central baffle spaced apart from the first and second sidewalls;
the first and second retention device engage the central baffle.

10. The air vent assembly of claim 8, wherein the first and second catch members comprise magnets.

11. The air vent assembly of claim 10, wherein the third catch member comprises a magnet.

12. The air vent assembly of claim 8, wherein the first and second retention devices comprise spring clips.

13. The air vent assembly of claim 8, wherein the first and second retention devices are formed of a resilient material.

14. The air vent assembly of claim 13, wherein the resilient material is one of the following: a metal, a plastic, an elastomer.

15. The air vent damper apparatus of claim 1, wherein each of the first and second retention devices includes a finger portion and an arm portion extending from the body portion and spaced apart by a channel.

16. An air vent damper apparatus, comprising:
first and second spring clips each formed of a resilient material and each having a respective body portion, wherein at least one retention device among the first and second retention devices includes at least a first catch member and at least one retention device among the first and second catch members includes a second catch member, and wherein the first and second catch members are magnets and define differing damper positions; and
a damper having opposed first and second edges, wherein the damper is pivotally coupled between the first and second retention devices with the first edge adjacent the first retention device and the second edge adjacent the second retention device, wherein each of the first and second edges has a respective third catch member magnetically attracted to the first and second catch members the first and second retention devices, such that the damper can be selectively configured in an first position by aligning the third catch member with the first catch member and can be selective configured in a second position by aligning the third catch member with the second catch member.

17. The air vent damper apparatus of claim 16, wherein each of the first and second retention devices includes a finger portion and an arm portion extending from the body portion and spaced apart by a channel.

18. The air vent damper apparatus of claim 16, wherein the resilient material is one of the following: a metal, a plastic, an elastomer.

19. A method of installing an air vent damper apparatus in an air vent of an automotive vehicle, the method comprising:
providing an air vent damper apparatus, including:
first and second retention devices each having a respective body portion, wherein at least one retention device among the first and second retention devices includes at least a first catch member and at least one retention device among the first and second catch members includes a second catch member, and wherein the first and second catch members define differing damper positions; and
a damper having opposed first and second edges, wherein the damper is pivotally coupled between the first and second retention devices with the first edge adjacent the first retention device and the second edge adjacent the second retention device, wherein each of the first and second edges has a respective third catch member magnetically attracted to the first and second catch members the first and second retention devices, such that the damper can be selectively configured in an first position by aligning the third catch member with the first catch member and can be selective configured in a second position by aligning the third catch member with the second catch member; and
placing the air vent damper apparatus within the air vent, such that the first and second retention devices engage first and second sidewalls of the air vent.

20. The method of claim 19, further comprising pivoting the damper from the first position to the second position.
